(19) United States
(12) Patent Application Publication
(10) Pub. No.: US 2005/0128291 A1
(43) Pub. Date: Jun. 16, 2005

(54) Video surveillance system

(76) Inventor: Yoshishige Murakami, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/959,677

(22) Filed: Oct. 5, 2004

Related U.S. Application Data
(63) Continuation of application No. PCT/JP02/03840, filed on Apr. 17, 2002.

(51) Int. Cl. H04N 7/18

(52) U.S. Cl. 348/143; 348/164; 348/169

(57) ABSTRACT

A video surveillance system that automatically keeps track of a moving object in an accurate and efficient manner. The system has two cameras for surveillance. One is a visible-light integrating camera that has a frame integration function to capture visible-light images of objects, and the other is an infrared camera for taking infrared images. A rotation unit tilts and pans the visible-light integrating camera and/or infrared camera, under the control of a tracking controller. Video output signals of those cameras are processed by image processors. The tracking controller operates with commands from a system controller, so that it will keep track of a moving object with the visible-light integrating camera in a first period and with the infrared camera in a second period.

This application is a continuing application, filed under 35 U.S.C. §111(a), of International Application PCT/JP02/03840, filed Apr. 17, 2002.

### BACKGROUND OF THE INVENTION

1. Field of the Invention

The present invention relates to a surveillance system, and more particularly to a surveillance system which performs video monitoring.

2. Description of the Related Art

Many of the existing video surveillance systems use multiple fixed cameras to observe a particular area and allow an operator to check the camera views on a video monitor screen. Some recent systems have automatic tracking functions to keep track of a moving object found in the acquired video images while changing the camera direction by controlling the rotator on which the camera is mounted.

Cameras suitable for surveillance purposes include high-sensitivity visible-light cameras and infrared cameras. As an example of a conventional system, Japanese Patent Application Publication No. 11-284988 (1999) describes the combined use of those different types of cameras. The system disclosed in this publication employs an infrared camera to detect an intruder and determine its movement direction. Based on that information, the system controls a visible-light camera such that the intruder comes into its view range. This control technique enables automatic tracking of an intruder even in a dark environment.

One drawback of the above-described conventional system, however, is that it requires in nighttime a light source like floodlights for a visible-light camera to form an image of an intruder. The use of lighting would increase the chance for an intruder to notice the presence of surveillance cameras.

Another drawback is that, since the visible-light camera does not move until an intruder is actually detected, the system may allow the intruder to pass the surveillance area without being noticed or lose sight of the intruder halfway through the tracking task. Yet another drawback of the proposed system is the lack of object discrimination functions. The camera sometimes follows an irrelevant object such as vehicles, thus missing real intruders.

### SUMMARY OF THE INVENTION

In view of the foregoing, it is an object of the present invention to provide a video surveillance system that automatically keeps track of moving object in an accurate and efficient manner.

To accomplish the above object, the present invention provides a video surveillance system. This system comprises the following elements: (a) a visible-light integrating camera having frame integration functions for taking visible-light video; (b) an infrared camera for taking infrared images; (c) a tracking controller comprising a rotation unit that rotates the visible-light integrating camera or infrared camera, and an image processor that processes video signals supplied from the visible-light integrating camera or the infrared camera; and (d) a system controller that commands the tracking controller to keep track of a moving object by using the visible-light integrating camera in a first period and the infrared camera in a second period.

The visible-light integrating camera takes visible-light video using its frame integration functions, while the infrared camera takes infrared video. The rotation unit rotates the visible-light integrating camera or infrared camera. The image processor processes video signals supplied from the visible-light integrating camera or infrared camera. The system controller commands the tracking controller to keep track of a moving object by using the visible-light integrating camera in a first period and the infrared camera in a second period.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a surveillance system according to the present invention.

FIG. 2 shows the concept of frame integration processing that a visible-light integrating camera performs.

FIGS. 3 to 5 show a specific structure of a surveillance system.

FIG. 6 shows relative locations of a moving object and a camera.

FIG. 7 shows a coordinate map used in prediction of a new object position.

FIG. 8 shows how two cameras are used in tracking and waiting operations.

FIG. 9 shows the structure of an image processor and a moving object discriminator.

FIG. 10 shows calculation of the length-to-width ratio of a labeled group of pixels.

FIG. 11 shows a movement path map.

FIG. 12 shows a variation of the surveillance system according to the present invention.

### DESCRIPTION OF THE PREFERRED EMBODIMENTS

Preferred embodiments of the present invention will be described below with reference to the accompanying drawings, wherein like reference numerals refer to like elements throughout.

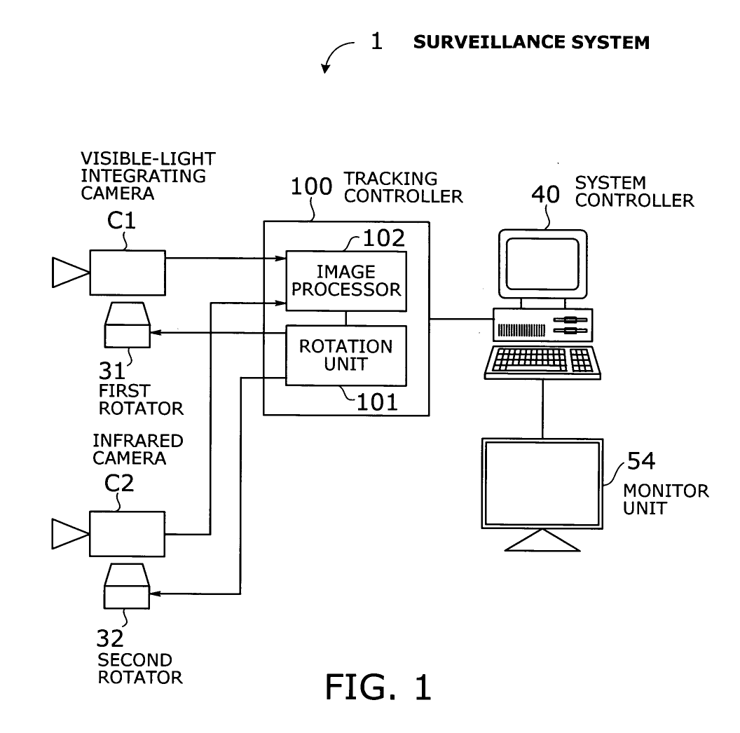

FIG. 1 is a conceptual view of a surveillance system according to the present invention. This surveillance system 1, falling under the categories of industrial TV (ITV) systems or security systems, is designed for video surveillance with a capability of automatically tracking moving objects (e.g., humans).

The surveillance system 1 has two cameras. One is a visible-light integrating camera C1 having a frame integration function to capture visible-light images of objects. The other is an infrared camera C2 that takes images using infrared radiation from objects.

Also provided is a tracking controller 100, which includes a rotation unit 101 and an image processor 102. The rotation unit 101 (hereafter “rotator driver”) controls either or both of two rotators 31 and 32, on which the visible-light integrating camera C1 and infrared camera C2 are mounted, respectively. The image processor 102 processes video signals from either or both of the visible-light integrating camera C1 or infrared camera C2.

The tracking controller 100 is controlled by a system controller 40 in such a way that, in tracking moving objects, the visible-light integrating camera C1 will work during a first period (e.g., daytime hours) and the infrared camera C2 will work during a second period (e.g., nighttime hours). The system controller 40 also receives visible-light video signals from the visible-light integrating camera C1, as well as infrared video signals from the infrared camera C2, for displaying camera views on a monitor unit 54.

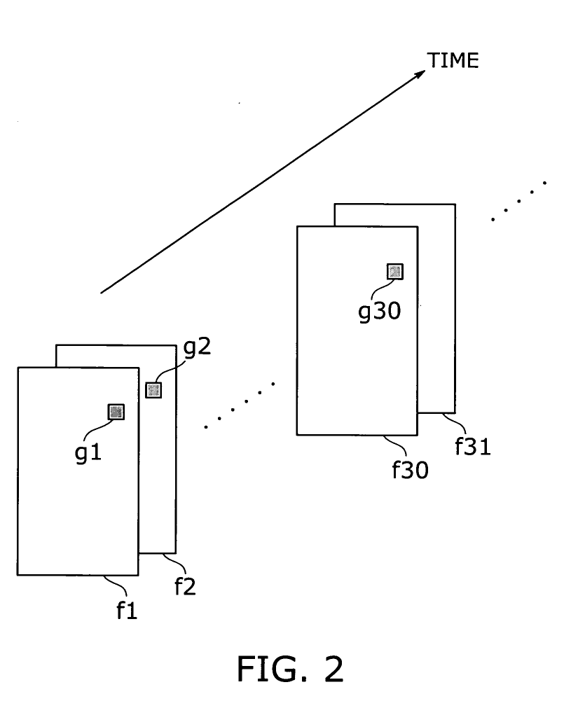

FIG. 2 shows the concept of frame integration processing that a visible-light integrating camera performs. Frame integration is a process of smoothing video pictures by adding up pixel values over a predetermined number of frames and then dividing the sum by that number of frames. Consider an integration process of 30 frames, for example. The pixel values (e.g., g1 to g30) at a particular point are added up over 30 frames f1 to f30, and the resulting sum is divided by 30. The integration process repeats such computation for every pixel constituting a frame, thereby producing one averaged frame picture. The next frame f31 becomes available after the passage of one frame interval Δt, which triggers another cycle of integration with frames f2 to f31. The frame integration technique increases effectively the sensitivity (minimum illuminance) of cameras. Thus the visible-light integrating camera C1 can pick up images in low-light situations.

The visible-light integrating camera C1 changes its operating mode to integration mode automatically when the illuminance level is decreased in nighttime hours. Since it averages over a period of time, the frame integration processing causes a slow response or produces afterimages of a moving object. According to the present invention, the system enables the infrared camera C2, instead of the visible-light integrating camera C1, during nighttime hours, so that those two different cameras will complement each other.

### Surveillance Operation

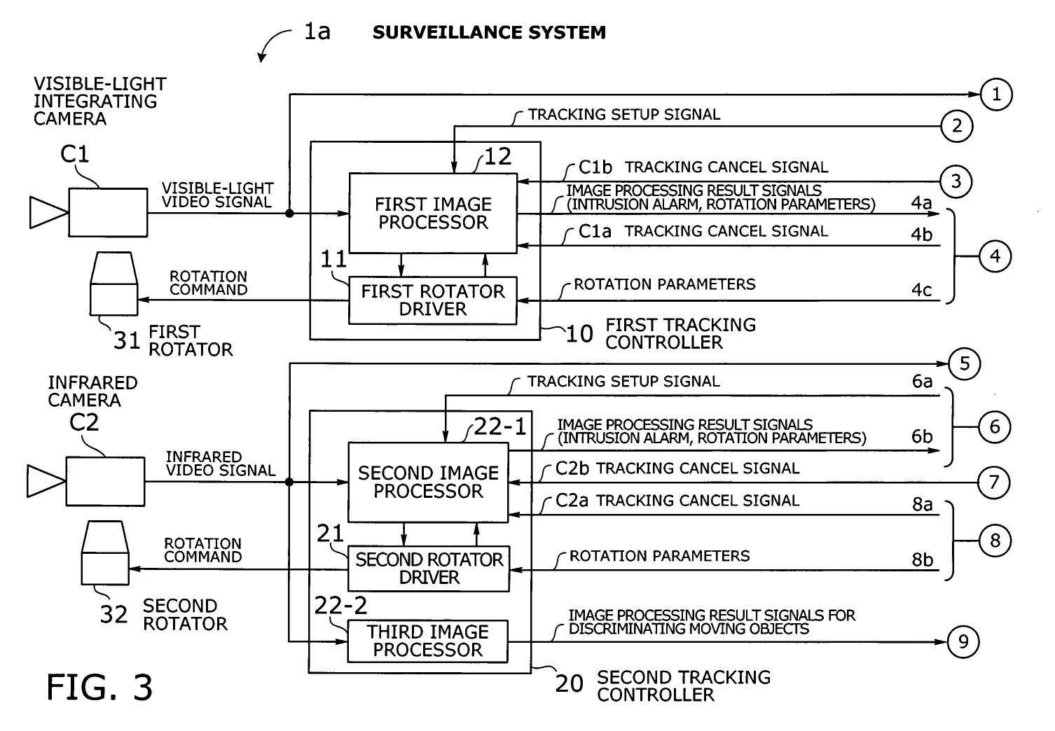

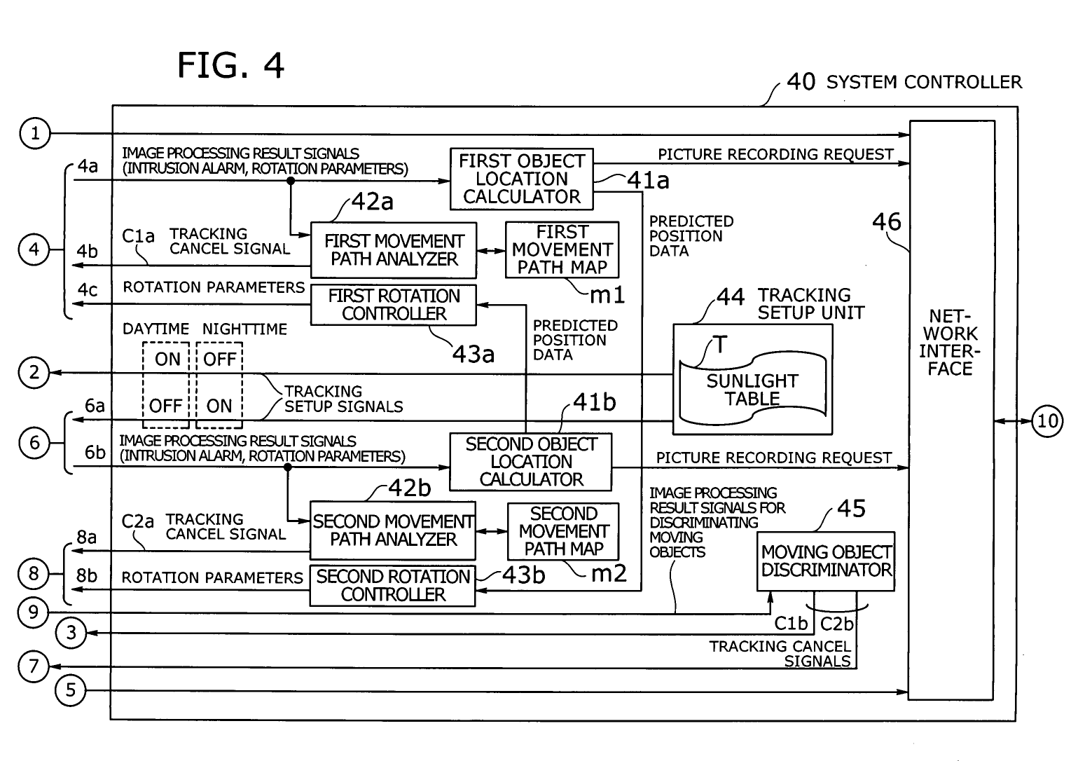

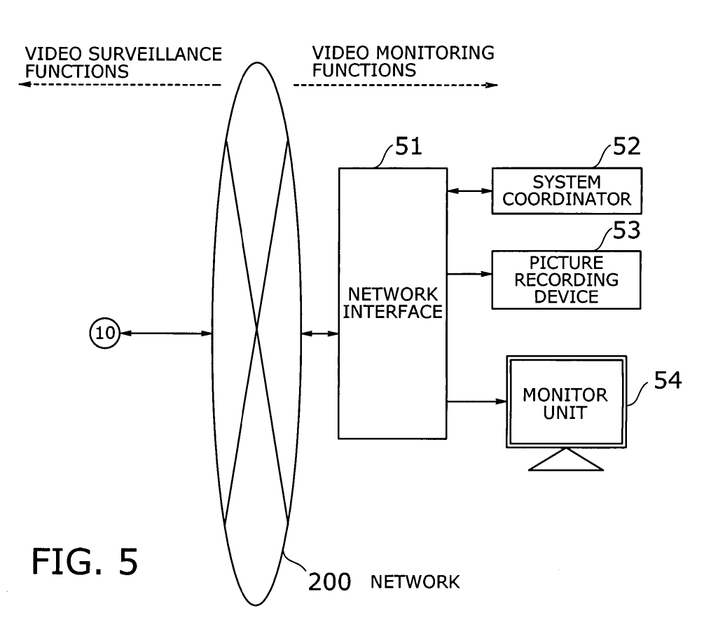

This section describes detailed structure and operation of the surveillance system 1 according to the present invention. FIGS. 3 to 5 give a more specific surveillance system 1a in which the above-described surveillance system 1 is combined with a network 200. This system 1a is largely divided into two parts. Shown at the left of the network 200 (see FIG. 5) are video surveillance functions, and shown at the right are video monitoring functions.

The video surveillance functions include a visible-light integrating camera C1, a first rotator 31 for tilting and panning the camera C1, a first tracking controller 10 for controlling the direction of the camera C1, an infrared camera C2, a second rotator 32 for tilting and panning the camera C2, a second tracking controller 20 for controlling the direction of the camera C2, and a system controller 40 for supervising the two tracking controllers 10 and 20. The video monitoring functions include a network interface 51, a system coordinator 52, a picture recording device 53, and a monitor unit 54.

During daylight hours, the surveillance system 1a operates as follows. A tracking setup unit 44 in the system controller 40 has a sunlight table T containing information about sunlight hours, which vary according to the changing seasons. The tracking setup unit 44 consults this sunlight table T to determine whether it is day or night. When it is determined to be daytime, the tracking setup unit 44 sends a tracking ON command signal to a first image processor 12 and a tracking OFF command signal to a second image processor 22-1.

When a moving object (which is possibly an intruder) enters the range of the visible-light integrating camera C1, the first image processor 12 processes visible-light video signals from the camera C1 to determine the object location, thus commanding a first rotator driver 11 to rotate the camera C1 such that the captured object image will be centered in its visual angle. With this rotation command, the first rotator driver 11 controls the first rotator 31 accordingly, so that the visible-light integrating camera C1 will track the intruder. The current position of the first rotator 31 (or of the visible-light integrating camera C1) is fed back to the first image processor 12 through the first rotator driver 11.

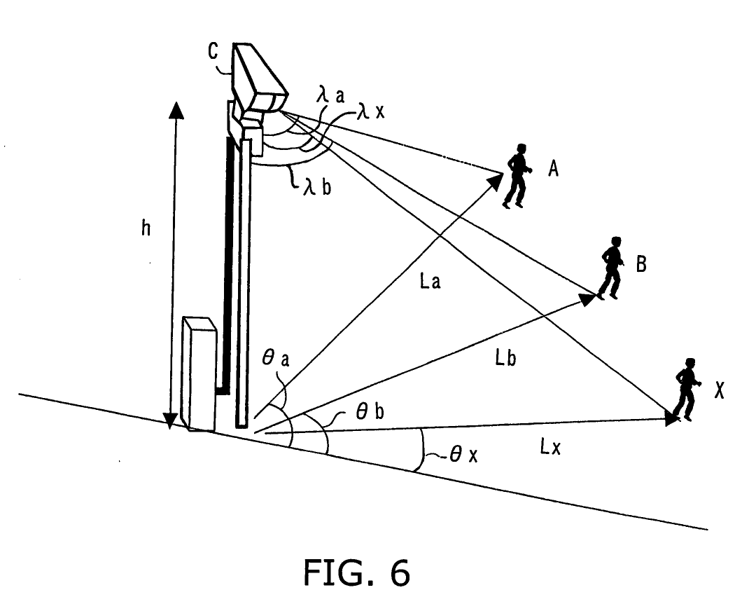

Following the object movement, the first image processor 12 supplies a first object location calculator 41a with image processing result signals, which include an intrusion alarm and rotation parameters. The rotation parameters includes tilt and pan angles of the camera being used. Each time new image processing result signals are received, the first object location calculator 41a plots the current object position on a coordinate map representing the tracking area. Two such positions on the map permit the first object location calculator 41a to predict the next position of the moving object and supply a second rotation controller 43b with the predicted position data. Details of this position prediction will be discussed later with reference to FIGS. 6 to 8.

The second rotation controller 43b calculates tilt and pan angles of the predicted position from given data and sends the resulting rotation parameters to the second rotator driver 21. The second rotator driver 21 activates the second rotator 32 according to those rotation parameters, thus directing the infrared camera C2 to the predicted object position. At that position, the infrared camera C2 waits for an object to come into view, while delivering infrared video signals to a network interface 46.

Also sent to the network interface 46 is visible-light video signals of the visible-light integrating camera C1. After being compressed with standard video compression techniques (e.g., JPEG, MPEG), those visible-light and infrared video signals are supplied to a picture recording device 53 and monitor unit 54 via the network 200 and a network interface 51 for the purposes of video recording and visual monitoring.

The first object location calculator 41a produces a picture recording request upon receipt of image processing result signals from the first image processor 12. This picture recording request reaches a system coordinator 52 through the local network interface 46, network 200, and remote network interface 51. The system coordinator 52 then commands the picture recording device 53 to record videos supplied from the visible-light integrating camera C1 and infrared camera C2.

The image processing result signals (including intrusion alarm and rotation parameters) are also sent from the first image processor 12 to the first movement path analyzer 42a at the same time as they are sent to the first object location calculator 41a. With the given rotation parameters, the first movement path analyzer 42a plots the path on a first movement path map m1, which is a two-dimensional coordinate plane, thereby recording movements of ordinary moving objects in the surveillance area. When frequent traces of objects are observed in particular blocks on the map m1, the operator designates these blocks as mask blocks.

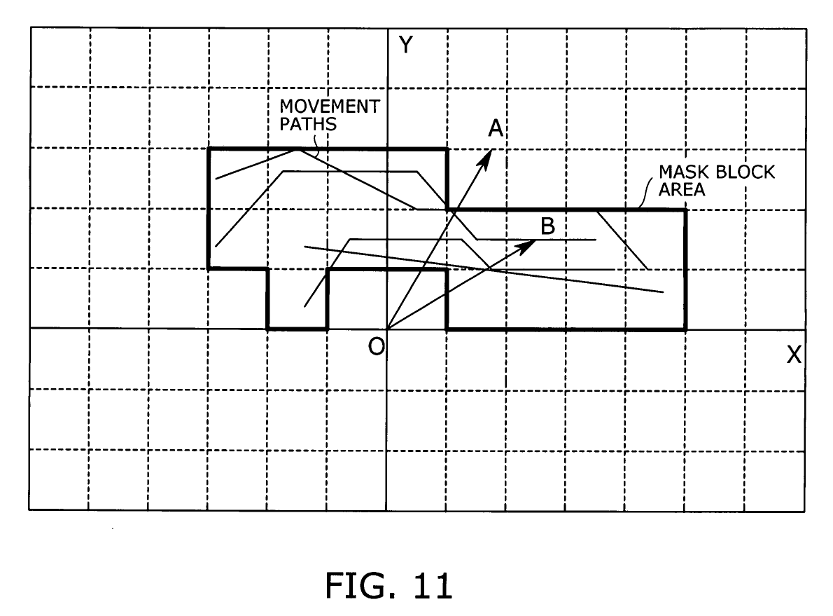

New intrusion alarms and rotation parameters supplied from the first image processor 12 may be of an object that falls within such mask blocks. If this is the case, the first movement path analyzer 42a sends a tracking cancel signal C1a to the first image processor 12 not to bother to perform unnecessary tracking. The first image processor 12 thus only tracks objects existing out of those mask blocks. Details of this movement path analysis will be described later with reference to FIG. 11.

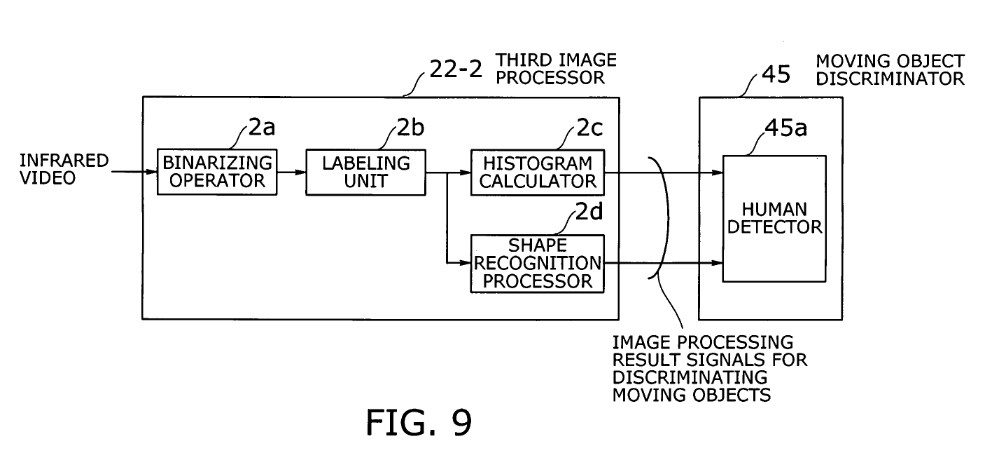

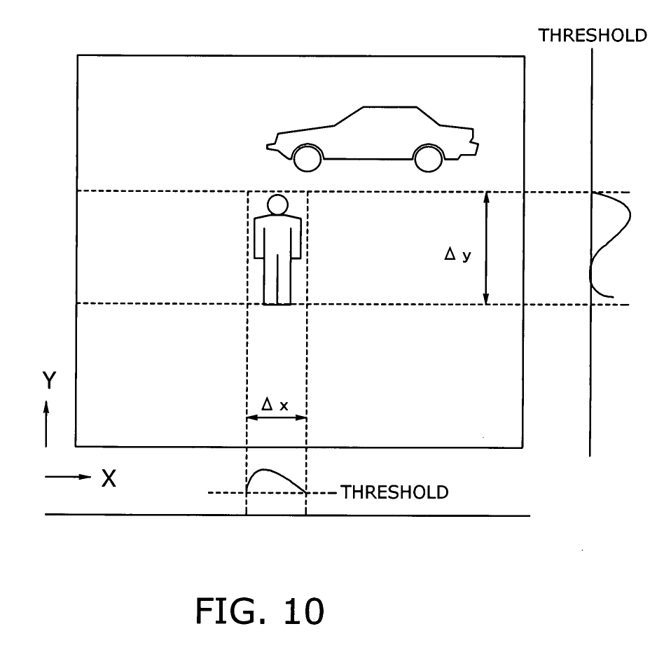

The third image processor 22-2, on the other hand, analyzes given infrared video signals with a course of image processing to recognize the shape of and count pixels of each labeled object in the way described later with reference to FIG. 9. The result is sent to a moving object discriminator 45 as image processing result signals for discriminating moving objects. The moving object discriminator 45 then discriminates moving objects on the basis of their respective length-to-width ratios and numbers of pixels, and if the object in question falls out of the scope of surveillance, it sends a tracking cancel signal C1b to the first image processor 12. For example, a tracking cancel signal C1b is generated if the moving object is not a human object. Details of this object discrimination process will be described later with reference to FIGS. 9 and 10.

The first image processor 12 stops tracking when a tracking cancel signal C1a is received from the first movement path analyzer 42a, or when a tracking cancel signal C1b is received from the moving object discriminator 45. The first image processor 12 then issues appropriate rotation parameters that command the first rotator driver 11 to return the first rotator 31 to its home position, thus terminating the series of tracking tasks.

During nighttime hours, the video surveillance system operates as follows. The tracking setup unit 44 consults sunlight table T to determine whether it is day or night. When it is determined to be nighttime, the tracking setup unit 44 sends a tracking OFF command signal to the first image processor 12 and a tracking ON command signal to the second image processor 22-1.

When a moving object (which is possibly an intruder) enters the range of the infrared camera C2, the second image processor 22-1 processes infrared video signals from the camera C2 to determine the object location, thus commanding the second rotator driver 21 to rotate the camera C2 such that the captured object image will be centered in its visual angle. With this rotation command, the second rotator driver 21 controls the second rotator 32 accordingly, so that the infrared camera C2 will track the intruder. The current position of the second rotator 32 (or of the infrared camera C2) is fed back to the second image processor 22-1 through the second rotator driver 21.

Following the object movement, the second image processor 22-1 supplies the second object location calculator 41b with image processing result signals, which include an intrusion alarm and rotation parameters. The rotation parameters includes tilt and pan angles of the camera being used. Each time new image processing result signals are received, the second object location calculator 41b plots the current object position on a coordinate map representing the tracking area. Two such positions on the map permit the second object location calculator 41b to predict the next position of the moving object and supply the first rotation controller 43a with the predicted position data. Details of this position prediction will be described later with reference to FIGS. 6 to FIG. 8.

The first rotation controller 43a calculates tilt and pan angles of the predicted position from given data and sends the resulting rotation parameters to the first rotator driver 11. The first rotator driver 11 activates the first rotator 31 according to the given rotation parameters, thus directing the visible-light integrating camera C1 to the predicted object position. At that position, the visible-light integrating camera C1 waits for an object to come into view, while delivering visible-light video signals to the network interface 46. As in the case of daytime, infrared video signals from the infrared camera C2 are also compressed and supplied to the network interface 46, for delivery to the picture recording device 53 and monitor unit 54.

The second object location calculator 41b produces a picture recording request upon receipt of image processing result signals from the second image processor 22-1. This picture recording request reaches the system coordinator 52 through the local network interface 46, network 200, and remote network interface 51. The system coordinator 52 then commands the picture recording device 53 to record videos supplied from the visible-light integrating camera C1 and infrared camera C2.

The image processing result signals (including intrusion alarm and rotation parameters) are also sent from the second image processor 22-1 to the second movement path analyzer 42b at the same time as they are sent to the second object location calculator 41b. With the given rotation parameters, the second movement path analyzer 42b plots the path on a second movement path map m2, which is a two-dimensional coordinate plane, thereby recording movements of ordinary moving objects in the surveillance area. When frequent traces of objects are observed in particular blocks on the map m2, the operator designates these blocks as mask blocks.

New intrusion alarms and rotation parameters supplied from the second image processor 22-1 may be of an object that falls within such mask blocks. If this is the case, the second movement path analyzer 42b sends a tracking cancel signal C2a to the second image processor 22-1 not to bother to perform unnecessary tracking. The second image processor 22-1 thus only tracks objects existing out of those mask blocks. Details of this movement path analysis will be described later with reference to FIG. 11.

The third image processor 22-2, on the other hand, analyzes the obtained infrared video with a course of image processing to recognize the shape of and count pixels of each labeled object in the way described later with reference to FIG. 9. The result is sent to the moving object discriminator 45 as image processing result signals for discrimination of moving objects. The moving object discriminator 45 then discriminates moving objects on the basis of their respective length-to-width ratios and numbers of pixels, and if the object in question is not the subject of surveillance, it sends a tracking cancel signal C2b to the second image processor 22-1. Details of this object discrimination process will be described later with reference to FIGS. 9 and 10.

The second image processor 22-1 stops tracking when a tracking cancel signal C2a is received from the second movement path analyzer 42b, or when a tracking cancel signal C2b is received from the moving object discriminator 45. The second image processor 22-1 then issues appropriate rotation parameters that command the second rotator driver 21 to return the second rotator 32 to its home position, thus terminating the series of tracking tasks.

When a moving object is captured by the visible-light integrating camera C1 or infrared camera C2, the corresponding image processor 12 or 22-1 alerts the corresponding object location calculator 41a or 41b by sending an intrusion alarm. This intrusion alarm may be negated after a while, meaning that the camera has lost sight of the object. To handle such situations, the object location calculators 41a and 41b may be designed to trigger an internal timer to send a wait command (not shown) to the corresponding image processors 12 and 22-1 to wait for a predetermined period. The wait command causes the visible-light integrating camera C1 or infrared camera C2 to zoom back to a predetermined wide-angle position and keep its lens face toward the point at which the object has been lost for the predetermined period. If the intrusion alarm comes back during this period, the camera C1 or C2 will be controlled to resume tracking. If the wait command expires with no intrusion alarms, the camera C1 or C2 goes back to a preset position that is previously specified by the operator. With this control function, the system can keep an intruder under surveillance.

### Object Motion Prediction

This section explains the first and second object location calculators 41a and 41b (collectively referred to as the object location calculator 41) in greater detail. The object location calculator 41 predicts the position of a moving object from given image processing result signals (intrusion alarm and rotation parameters). More specifically, the object location calculator 41 maps the tilt and pan angles of a camera onto a two-dimensional coordinate plane. It then calculates the point where the object is expected to reach in a specified time, assuming that the object keeps moving at a constant speed.

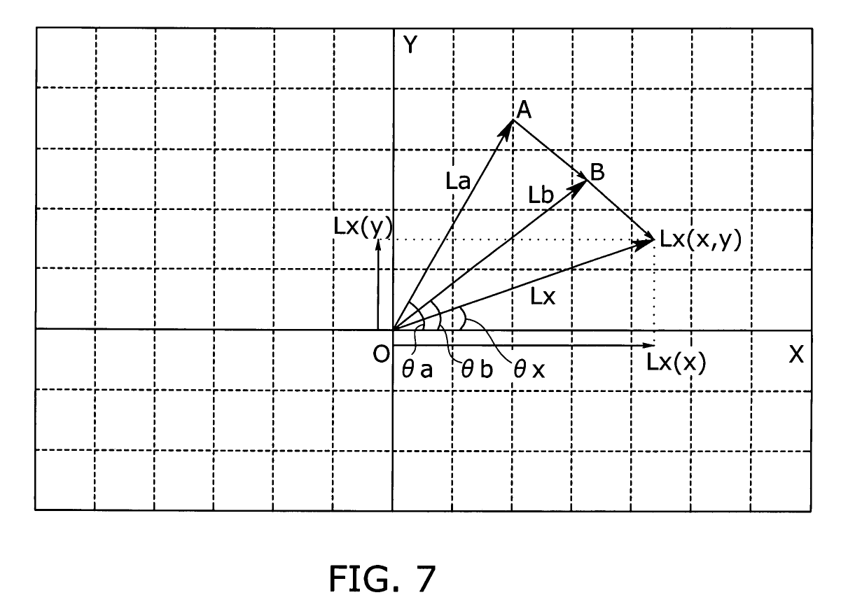

FIG. 6 shows relative locations of a moving object and a camera. FIG. 7 shows a coordinates map used in calculation of a predicted object position. Suppose now that the camera C has caught sight of an intruder at point A. The camera C then turns to the intruder, so that the object image will be centered in the view area. Tilt angle % a and pan angle θa of the camera rotator at this state are sent to the object location calculator 41 through a corresponding image processor. Since the height h of the camera C is known, the object location calculator 41 can calculate the distance La of the intruder (currently at point A) according to the following formula (1). The point A is then plotted on a two-dimensional coordinate plane as shown in FIG. 7.
La=tan(λa)·h (1)
A new intruder position B after a unit time is calculated in the same way, from a new tilt angle λb and pan angle θb. Specifically, the following formula (2) gives the distance Lb:
Lb=tan(λb)·h (2)
The calculated intruder positions are plotted at unit intervals as shown in FIG. 7, where two vectors La and Lb indicate that the intruder has moved from point A to point B. Then assuming that the intruder is moving basically at a constant speed, its future position X, or vector Lx, is estimated from the coordinates of point B and the following formula (3):
\vec{Lx}=2·\vec{Lb}−\vec{La} (3)
This position vector Lx(x, y) gives a predicted pan angle Ox and a predicted tilt angle λx according to the following two formulas (4a) and (4b):
θx=tan⁻¹(Lx(y)/Lx(x)) (4a)
λx=tan⁻¹(Lx/h) (4b)
where Lx (x) and Lx (y) are x-axis and y-axis components of vector Lx.

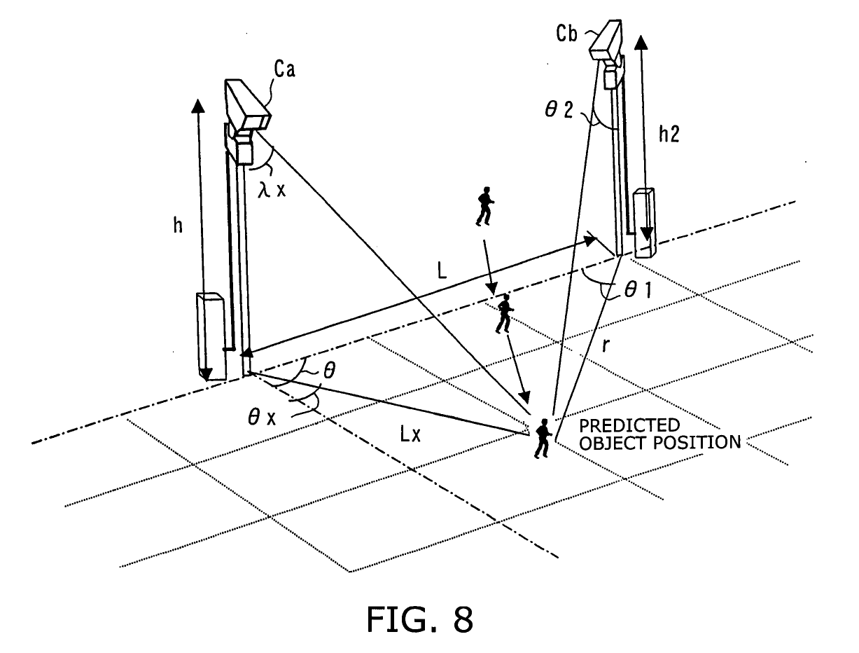

FIG. 8 shows how two cameras are used in tracking and waiting operations. Suppose now that a predicted position is given from the above-described calculation, and that another camera Cb (waiting camera) is placed such that its view range overlaps with that of the camera Ca (tracking camera). Then the following three formulas (5), (6a), and (6b) will give the distance r, pan angle θ1, and tilt angle θ2 of the waiting camera Cb.
r=(L+Lx−2·L·Lx·cos(θ−θx))/2 (5)
θ1=cos⁻¹((L+r−Lx)/(2L·r)) (6a)
θ2=tan⁻¹(r/h2) (6b)
where L, h2, and θ are known from the mounting position of camera Cb, and Lx, λx, and θx are outcomes of the above formulas (4a) and (4b).

The object location calculator 41 calculates tilt angle θ2 and pan angle θ1 of the waiting camera Cb in the way described above and sends them to the corresponding rotator driver and rotation controller for that camera Cb, thereby directing the camera Cb against the predicted intruder position.

### Moving Object Discrimination

This section describes the process of discriminating moving objects. FIG. 9 shows the structure of the third image processor 22-2 and moving object discriminator 45. The third image processor 22-2 includes a binarizing operator 2a, a labeling unit 2b, a histogram calculator 2c, and a shape recognition processor 2d. The moving object discriminator 45 includes a human detector 45a.

The binarizing operator 2a produces a binary picture from a given infrared image of the infrared camera C2 by slicing pixel intensities at a predetermined threshold. Every pixel above the threshold is sent to the labeling unit 2b, where each chunk of adjoining pixels will be recognized as a single group and labeled accordingly. For each labeled group of pixels, the histogram calculator 2c produces a histogram that represents the distribution of pixel intensities (256 levels). The shape recognition processor 2d calculates the length-to-width ratio of each labeled group of pixels. Those image processing result signals (i.e., histograms and length-to-width ratios) are supplied to the human detector 45a for the purpose of moving object discrimination. The human detector 45a then determines whether each labeled group represents a human body object or any other object.

FIG. 10 depicts the length-to-width ratio of a labeled group of pixels. As seen, the shape recognition processor 2d measures the vertical length Δy and horizontal length Δx of this pixel group and then calculates the ratio of Δy:Δx. If the object is a human, the shape looks taller than it is wider. If the object is a car, the shape looks wider and has a large number of pixels. The range of length-to-width ratios for each kind of moving objects is defined previously, allowing the moving object discriminator 45 to differentiate between moving objects by comparing their measured length-to-width ratios with those set values.

### Movement Path Analysis

This section describes the first and second movement path analyzers 42a and 42b (collectively referred to as movement path analyzers 42). FIG. 11 shows a movement path map m. The movement path analyzer 42 creates such a movement path map m on a two-dimensional coordinate plane to represent the scanning range, or coverage area, of a camera. The movement path map m is divided into a plurality of small blocks, and the movement path analyzer 42 records given movement paths of ordinary moving objects on those blocks. Note that the term “ordinary moving objects” refers to a class of moving objects that are not the subject of surveillance, which include, for example, ordinary men and women and vehicles moving up and down the road. Blocks containing frequent movement paths are designated as mask blocks according to operator instructions. The movement path analyzer 42 regards the objects in such mask blocks as ordinary moving objects.

When the camera detects an object, the movement path analyzer 42 calculates its coordinates from the current tilt and pan angles of the camera and determines whether the calculated coordinate point is within the mask blocks on the movement path map m. If it is, the movement path analyzer 42 regards the object in question as an ordinary moving object, thus sending a tracking cancel signal to avoid unnecessary tracking. If not, the movement path analyzer 42 permits the corresponding image processor to keep tracking the object.

### Variation of Surveillance System

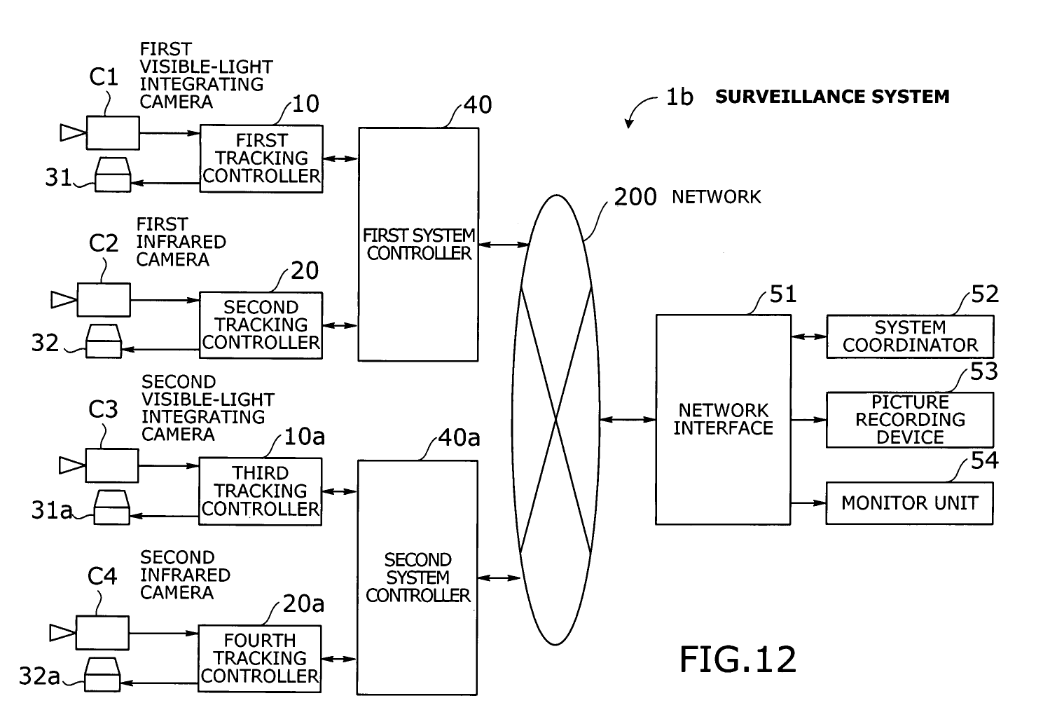

This section presents a variation of the surveillance system 1a, with reference to its block diagram shown in FIG. 12. In addition to the components shown in FIGS. 3 to 5, this surveillance system 1b has another set of video surveillance functions including: a visible-light integrating camera C3, an infrared camera C4, rotators 31a and 32a, tracking controllers 10a and 20a, and a system controller 40a.

Suppose that an intruder comes into the range of the first visible-light integrating camera C1. As described earlier in FIGS. 3 to 5, this event causes the corresponding object location calculator in the first system controller 40 to receive an intrusion alarm and rotation parameters, thus starting to keep track of the intruder. Rotation parameters indicating the predicted object position are sent to the rotation controller of the first infrared camera C2, so that the camera C2 will turn toward the intruder.

In the surveillance system 1b, the same rotation parameters are also sent to the system coordinator 52 via the network 200 and network interface 51. Since the mounting position of the second visible-light integrating camera C3 is known, the system coordinator 52 can calculate the tilt and pan angles of the camera C3 so as to rotate it toward the predicted intruder position. Those parameters are delivered to the corresponding rotation controller (not shown) in the second system controller 40a through the network interface 51 and network 200, thus enabling the second visible-light integrating camera C3 to wait for the intruder to come into its view range. The same control technique applies to the first and second infrared cameras C2 and C4. In this way, the surveillance system 1b keeps observing the intruder without interruption.

### Conclusion

To summarize the above discussion, the proposed surveillance system has a visible-light integrating camera C1 and an infrared camera C2 and consults a sunlight table T to determine which camera to use. In daytime hours, the visible-light integrating camera C1 keeps track of a moving object, while the infrared camera C2 waits for a moving object to come into its view range. In nighttime hours, on the other hand, the infrared camera C2 keeps track of a moving object, while the visible-light integrating camera C1 waits for a moving object to come into its view range. This structural arrangement enables the system to offer 24-hour surveillance service in more accurate and efficient manner. The use of a visible-light integrating camera C1 eliminates the need for floodlights, thus making it possible to follow the intruder without his/her knowledge.

The proposed system further provides a function of determining whether an observed moving object is a subject of surveillance. If it is, the system continues tracking that object. Otherwise, the system cancels further tracking tasks for that object.

The system also defines mask blocks by analyzing movement paths of objects. Objects found in mask blocks are disregarded as being ordinary moving objects out of the scope of surveillance. This feature avoids unnecessary tracking, thus increasing the efficiency of surveillance.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A video surveillance system, comprising:
(a) a visible-light integrating camera having frame integration functions for taking visible-light video;
(b) an infrared camera for taking infrared images;
(c) a tracking controller comprising:
a rotation unit that rotates said visible-light integrating camera and/or infrared camera, and
an image processor that processes video signals supplied from said visible-light integrating camera and/or said infrared camera; and
(d) a system controller that commands said tracking controller to keep track of a moving object by using the visible-light integrating camera in a first period and the infrared camera in a second period.

2. The surveillance system according to claim 1, wherein said system controller recognizes the first and second period, based on a sunlight table that contains information about sunlight hours which vary according to seasons.

3. The surveillance system according to claim 1, wherein:
said system controller predicts a new position of the moving object; and
said system controller causes said infrared camera to be directed to the predicted new position to wait for the moving object, when said visible-light integrating camera is activated in tracking the moving object during the first period.

4. The surveillance system according to claim 1, wherein:
said system controller predicts a new position of the moving object; and
said system controller causes said infrared camera to be directed to the predicted new position to wait for the moving object, when said infrared camera is activated in tracking the moving object during the second period.

5. The surveillance system according to claim 1, wherein:
said system controller discriminates moving objects from image-processing results; and
said system controller sends out a tracking cancel signal when a detected moving object is not a subject of surveillance.

6. The surveillance system according to claim 5, wherein:
said image processor outputs a length-to-width ratio and a histogram of a given infrared image by performing binarization, labeling, histogram calculation, and shape recognition processes; and
said system controller detects a human object, based on the length-to-width ratio and the histogram, in the course of discriminating moving objects.

7. The surveillance system according to claim 1, wherein said system controller analyzes paths of moving objects to avoid tracking of ordinary moving objects.

8. The surveillance system according to claim 7, wherein:
said system controller creates a movement path map by converting given tilt and pan angles of said visible-light integrating camera or infrared camera into points on a two-dimensional coordinate plane;
the movement path map is divided into a plurality of blocks, which include mask blocks; and
said system controller disregards moving objects in the mask blocks as being ordinary moving objects out of scope of surveillance.

9. The surveillance system according to claim 1, wherein:
said system controller temporarily suspends tracking when said visible-light integrating camera or infrared camera has lost track of the moving object;
said system controller resumes tracking from a point where the moving object was missed, when the moving object comes into view again; and
said system controller causes said visible-light integrating camera or infrared camera to return to a preset position, when no moving object comes back.

10. A tracking controller, for use with a visible-light integrating camera having frame integration functions for taking visible-light video or an infrared camera for taking infrared images, to keep track of an intruder, the tracking controller comprising:
a rotation unit that rotates the visible-light integrating camera and/or infrared camera; and
an image processor that processes video signals from the visible-light integrating camera and/or said infrared camera.

11. A system controller for use in a video surveillance system with a visible-light integrating camera having frame integration functions for taking visible-light video or an infrared camera for taking infrared images, the system controller comprising:
a network interface; and
a controller that causes the visible-light integrating camera to keep track of a moving object in a first period and the infrared camera to keep track of a moving object in a second period.

12. A video surveillance method comprising the steps of:
providing a sunlight table containing information about sunlight hours which vary according to seasons;
recognizing first and second periods, based on the sunlight table;
predicting a new position of a moving object;
providing a visible-light integrating camera having frame integration functions for taking visible-light video and an infrared camera for taking infrared images;
keeping track of a moving object with the visible-light integrating camera in the first period while directing the infrared camera toward the predicted new position to wait for the moving object to come into view; and
keeping track of a moving object with the infrared camera in the second period while directing the visible-light integrating camera toward the predicted new position to wait for the moving object to come into view.
